(19) United States
(12) Patent Application Publication
(10) Pub. No.: US 2007/0005303 A1
(43) Pub. Date: Jan. 4, 2007

(54) Optical disk drive capable of providing a simulation function

(75) Inventor: Po-Tai Huang, Hsinchu City (TW)

Correspondence Address: BRUCE H. TROXELL, SUITE 1404, 5205 LEESBURG PIKE, FALLS CHURCH, VA, 22041, US

(73) Assignee: LITE-ON IT CORPORATION

(21) Appl. No.: 11/333,404

(22) Filed: Jan. 18, 2006

(30) Foreign Application Priority Data
Jun. 24, 2005 (TW) 94121269

(51) Int. Cl. G06F 11/00

(52) U.S. Cl. 702/188

(57) ABSTRACT

An optical disk drive for installing within a computer system includes a storage module and a simulation module capable of simulating the optical disk drive as a data-storage device in cooperation with a processor of the computer system to access the storage module. The optical disk drive determines whether the simulation module is activated or not in order to conduct a simulation function based on a mode-switching signal.

### FIELD OF THE INVENTION

The present invention relates to a optical disk drive, more particularly to an optical disk drive that is installed within a computer system and that includes a simulation module and a storage module such that the computer system is capable of accessing the storage module via the simulation module.

### BACKGROUND OF THE INVENTION

FIG. 1 is a block diagram illustrating how an operating system is loaded from the hard disk drive by a processor in a computer system. The computer system 2 includes a processor 10 that can drive or administer the peripheral software and hardware after the operating system 4a being loaded. Since a relatively large storage space is usually required to store the operating system 4a, the operating system 4a can be stored in a hard disk drive 8 of the computer system 2. Upon pressing of an On/Off switch 6 mounted on the outer casing of the computer, the BIOS (Basic Input Output System) 14 stored within the ROM (Read-Only memory) is firstly loaded by the processor 10 so that the computer system 2 can process basic input and output operations, such as displaying basic information on a monitor, receiving input signal from the keyboard, and access the hard disk drive 8 or the optical disk drive 12 via the IDE (Integrated Device Electronics) interfaces. Afterward, the operating system 4a stored within the hard disk drive 8 is loaded if the hard disk drive 8 is assigned to be the boot drive based on the setting of the BIOS 14, thereby completing the booting operation of the computer system 2.

Conventionally, when the operating system 4a has never been installed into the computer system 2, the computer system 2 has to load the operating system from place other than the hard disk drive 8. In addition, when there is malfunction of the hard disk drive 8 or ruined data of the stored operating system 4a, the processor 10 will not be able to load the operating system 4a, and the computer system 2 cannot be booted eventually.

FIG. 2 is a block diagram illustrating how an operating system is loaded from the optical disk drive by a processor in a computer system. Presence and utilization of the optical disk drive greatly facilitates the user in data access and data preservation. Lately, the optical disk drive has become an indispensable part in a computer system or a consumer electronic device. When the optical disk 16 present in the optical disk drive 12 contains the operating system 4b, the processor 10 can be arranged to load the operating system 4b stored in the optical disk 16 according to the setting of the BIOS 14. Such kind of operation for loading the operating system can eliminate a certain problem of the over relying on the hard disk drive 8.

FIG. 3 illustrates the method for loading an operating system stored within the optical disk drive by the processor in a conventional computer system. In the step S30, when the optical disk drive 12 has been assigned as the boot drive based on the setting of the BIOS 14, the processor 10 starts loading an operating system 4b from the optical disk drive 12. Then in step S32, the optical disk drive 12 conducts a reading operation of the data stored in the optical disk 16, wherein the data can be the operating system 4b for running the computer system 2. If the operating system 4b is stored in the optical disk 16, the operating system 4b is loaded into the computer system 2 in step S34, thereby completing the booting of the computer system and finishing the loading of the operating system according to the step S36.

In the aforesaid method, it is necessary to have an optical disk 16 with the operating system 4b to boot the computer system 2 from the optical disk drive 12. Lack of the optical disk 16 with the operating system 4b stored therein within, the optical disk drive 12 could result in malfunction of the computer system 2.

### SUMMARY OF THE INVENTION

The object of the present invention is to provide an optical disk drive that is to be installed within the computer system and that includes a simulation module and a storage module such that the computer system is capable of accessing the storage module via the simulation module.

In accordance with the present invention, an optical disk drive for installing within a computer system that includes a processor is disclosed. The optical disk drive is capable of providing a simulation function and includes a storage module and a simulation module capable of simulating the optical disk drive as a data storage device and cooperating with the processor of the computer system to access the storage module. The optical disk drive determines whether the simulation module is activated or not in order to conduct the simulation function based on a mode-switching signal.

In another aspect of the present invention, a switching method is proposed for enabling or disabling a simulation function provided by a simulation module of an optical disk drive. The switch method includes the steps of: determining whether the simulation module is activated or not based on a mode-switching signal when the optical disk drive is powered on or reset; activating the simulation module when it is determined to enable the simulation function so as to simulate the optical disk drive as a data storage device; and de-activating the simulation module when it is determined to disable the simulation function.

In still another aspect of the present invention, a method for loading an operating system in a computer system is provided. The computer system includes a processor, a BIOS (basic input output system), and an optical disk drive having a simulation module and a storage module that is stored with an operating system. The loading method includes the steps of: activating the simulation module of the optical disk drive to enable a simulation function so that the processor is capable of accessing the storage module via the simulation module; determining whether to load the operating system from the optical disk drive by the processor based on setting of the BIOS; and reading operation requested by the processor is conducted by the optical disk drive so as to access the operating system stored within the storage module when it is determined to load the operating system from the optical disk drive.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a block diagram illustrating how an operating system is loaded from the hard disk drive by a processor in the conventional computer system;

FIG. 2 is a block diagram illustrating how an operating system is loaded from the optical disk drive by a processor in the conventional computer system;

FIG. 3 illustrates the method for loading an operating system stored within the optical disk drive by a processor in the conventional computer system;

FIG. 4 is a block diagram illustrating a computer system equipped with the optical disk drive of the present invention;

FIG. 5 illustrates the steps in a switching method to enable or disable a simulation function provided by a simulation module employed in the optical disk drive of the present invention; and

FIG. 6 illustrates a method for loading an operating system in a computer system by using a simulation module and a storage module employed in the optical disk drive of the present invention.

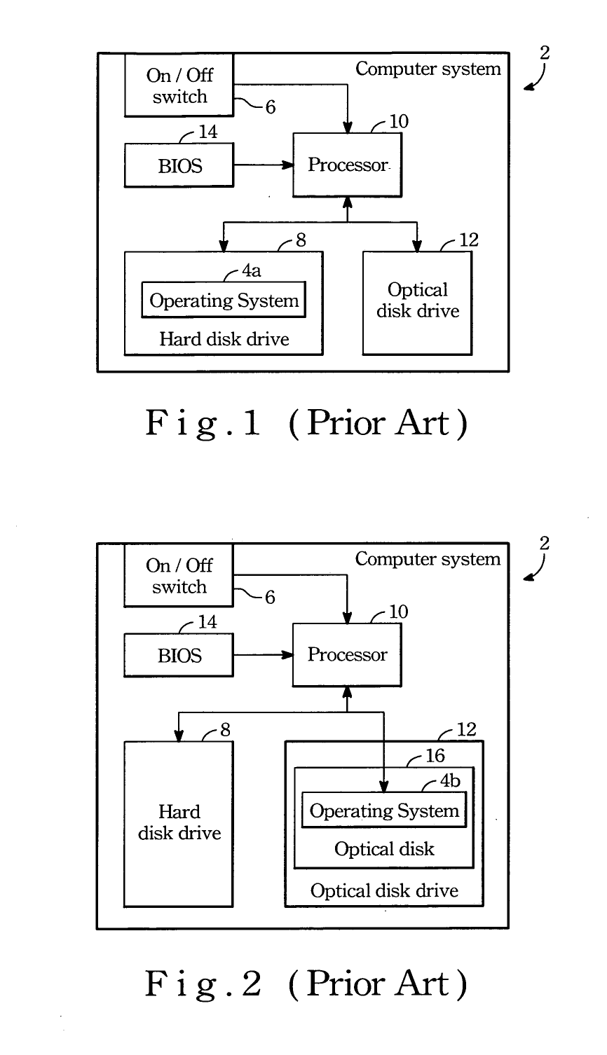

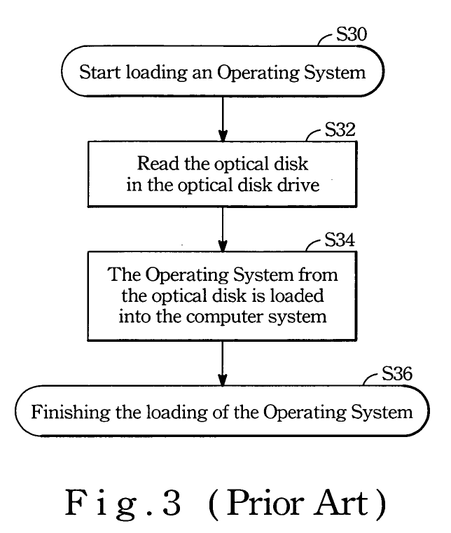

### DETAILED DESCCRIPTIONS OF THE PREFERRED EMBODIMENT

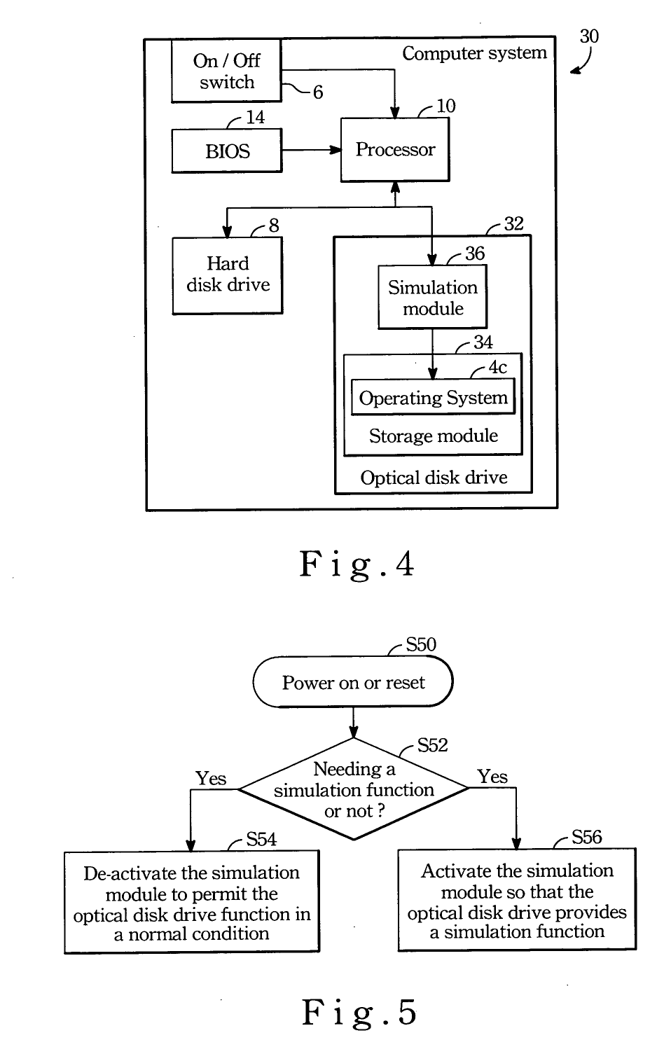

FIG. 4 is a block diagram illustrating a computer system equipped with an embodiment of the optical disk drive 32 of the present invention. The computer system 30 accordingly includes a processor 10, a hard disk drive 8, and the optical disk drive 32. The optical disk drive 32 of the present invention includes a storage module 34 and a simulation module 36 in addition to the conventional electronic components, such as a pick-up head for reading an optical disk, a spindle motor for rotating the optical disk if inserted, and a microprocessor for controlling operation of the optical disk drive 32. An operating system 4c is stored within the storage module 34. The simulation module 36 can simulate the optical disk drive 32 as a data storage device that is compatible with the IDE standard such that the processor can access the storage module via the simulation module by using IDE commands. For instance, the simulation module 36 is adapted to simulate the optical disk drive 32 as a hard disk drive or a floppy disk drive, and in such a manner that the storage module 34 can be simulated as a hard disk or a floppy disk. In this embodiment, the simulation module 36 simulates the image data file stored in the storage module 34 as an optical disk such that the optical disk can be handled just like a true disk by the microprocessor of the optical disk drive 32. At this time, a real optical disk is not required to be inserted in the optical disk drive 32, and the processor 10 of the computer system 30 will treat the virtual disk simulated by the simulation module 36 as the disk loaded in the optical disk drive 32 without noticing the absence of the physical optical disk.

The simulation module 36 could be implemented by an independent hard-wired circuitry. In this embodiment, the simulation module is implemented by a section of firmware executed by the microprocessor of the optical disk drive 32. When the optical disk drive receives an access command, the microprocessor will forward the request to the simulation module 36 for information. At this time, the simulation module 36 accesses the storage module 34 in order to fetch the data at a corresponding address. The storage module 34 could be a removable flash memory card (such as SD, MMC or CF), EEPROM (Electrically Erasable Programmable Read-Only Memory), EPROM (Erasable Programmable Read-Only Memory), or OTPROM (One Time Program Read-Only Memory) and etc. In this embodiment, a built-in flash memory is used as the storage module 34.

FIG. 5 illustrates the steps in a switching method to enable or disable a simulation function provided by a simulation module employed in the optical disk drive 32 of the present invention. When the optical disk drive 32 is powered on or is reset as shown in step S50, the process moves to step 52 to determine whether the simulation function is enabled or not based on a mode-switching signal. For instance, the mode-switching signal can be generated according to the pressing or release of a function switch mounted on the outer casing of the optical disk drive 32. The mode-switching signal can be generated according to whether the function switch or an ejection button is pressed beyond a predetermined time interval, or the mode-switching signal can be generated when a predetermined number of pressing actions are applied onto the function switch or the ejection button. Alternately, the mode-switching signal can be generated according to the setting of the BIOS during booting operation of the computer system, or setting done by a software program in a previous operation of the computer system 30 to determine whether to enable or disable the simulation function of the optical disk drive 32.

In step S52, if the optical disk drive 32 of the present invention is required to provide the simulation function, the simulation module 36 is activated and the process moves to step S56. As described in the aforesaid paragraph, the simulation module 36 simulates the storage module 34 as an optical disk (such as a CD-RW or DVD+RW disk). Under this condition, the computer system can perform the reading, writing, or re-writing operations on the simulated optical disk in cooperation with the conventional operation software. On the other hand, the process enters the step S54 if the optical disk drive 32 is not required to provide the simulation function. The simulation module 36 is de-activated and the optical disk drive 32 of the present invention can be used as a normal optical disk drive.

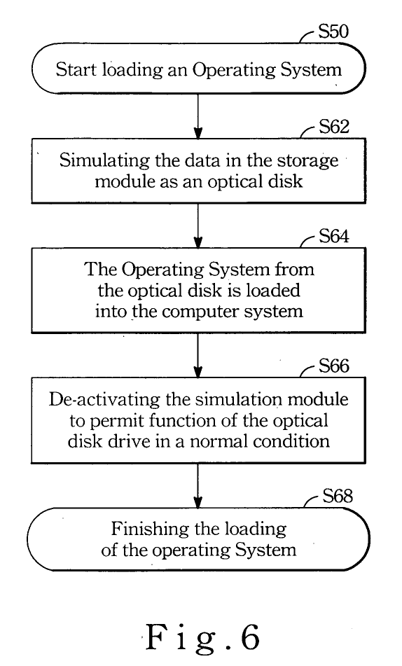

FIG. 6 illustrates a method for loading an operating system in a computer system by using a simulation module and a storage module employed in the optical disk drive of the present invention. For example, by pressing the function switch or the ejection button provided on the outer casing of the optical disk drive 32 for more than 5 seconds, the optical disk drive 32 is required to provide the simulation function, i.e. the simulation module 36 accesses the image file within the storage module 34 and latter simulates the image file as the optical disk that is stored with an operating system 4c for booting the compute system. First in step S60, the processor 10 requests loading of the operating system from the optical disk drive 32 based on the setting of the BIOS. Then in step S62, the processor 10 requests for data stored in the storage module 34 since the optical disk drive 32 has been working under the simulation function. If the operating system 4c is present in the storage module 34, the loading of the operating system 4c is conducted according to the step S64. In step S66, once the operating system is loaded, the optical disc drive 32 is reset so as to disable the simulation function and allow the optical disk drive 32 to be used as a normal optical disk drive. Under this condition, loading of the operating system 4c is completed according to the step S68.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An optical disk drive for installing within a computer system that includes a processor, the optical disk drive comprising:
a storage module; and
a simulation module capable of simulating the optical disk drive as a data storage device and cooperating with the processor of the computer system to access said storage module;
wherein the optical disk drive determines whether said simulation module is activated or not in order to conduct the simulation function based on a mode-switching signal.

2. The optical disk drive according to claim 1, further comprising an outer casing and a function switch mounted on and exposed to said outer casing, said mode-switching signal being generated when said function switch is pressed or released.

3. The optical disk drive according to claim 1, further comprising an outer casing and an ejection button mounted on and exposed to said outer casing, said mode-switching signal being generated when said ejection button is pressed beyond a predetermined time interval.

4. The optical disk drive according to claim 1, further comprising an outer casing and an ejection button mounted on and exposed to said outer casing, said mode-switching signal being generated when a predetermined number of pressing actions are applied onto said ejection button.

5. The optical disk drive according to claim 1, wherein the computer system further includes a BIOS (basic input output system) and said mode-switching signal is generated according to setting of said BIOS during booting operation of the computer system.

6. The optical disk drive according to claim 1, wherein the computer system further includes a BIOS and a software program, and said mode-switching signal is generated according to setting done by said software in a previous operation of the computer system.

7. The optical disk drive according to claim 1, wherein said storage module is a removable flash card, EEPROM (electrically erasable programmable read only memory), EPROM (erasable programmable read-only memory), OTPROM (one time program read-only memory), or a built-in flash memory.

8. The optical disk drive according to claim 1, wherein said simulation module includes a hard-wired circuitry or a microprocessor for executing a section of firmware.

9. The optical disk drive according to claim 1, wherein said simulation module simulating an image file stored in said storage module as an optical disk.

10. A switching method for enabling or disabling a simulation function provided by a simulation module of an optical disk drive, the switch method comprising the steps of:
determining whether the simulation module is activated or not based on a mode-switching signal when said optical disk drive is powered on or reset;
activating the simulation module when it is determined to enable the simulation function so as to simulate the optical disk drive as a data storage device; and
de-activating the simulation module when it is determined to disable the simulation function.

11. The switching method according to claim 10, wherein the optical disk drive further includes an outer casing and a function switch mounted on and exposed to said outer casing, said mode-switching signal being generated when said function switch is pressed or released.

12. The switching method according to claim 10, wherein the optical disk drive further includes an outer casing and an ejection button mounted on and exposed to said outer casing, said mode-switching signal being generated when said ejection button is pressed beyond a predetermined time interval.

13. The switching method according to claim 10, wherein the optical disk drive further includes an outer casing and an ejection button mounted on and exposed to said outer casing, said mode-switching signal being generated when a predetermined number of pressing actions are applied onto said ejection button.

14. The switching method according to claim 10, wherein the optical disk drive is employed in a computer system that includes a BIOS (basic input output system), said mode-switching signal is generated according to setting of said BIOS during booting operation of the computer system.

15. The switching method according to claim 10, wherein the optical disk drive is employed in a computer system that includes a BIOS and a software program, said mode-switching signal being generated according to setting done by the software program in a previous operation of the computer system.

16. A method for loading an operating system in a computer system, the computer system including a processor, a BIOS (basic input output system), and an optical disk drive having a simulation module and a storage module, the storage module being stored with an operating system, the loading method comprising the steps of:
activating the simulation module of the optical disk drive to enable a simulation function so that the processor is capable of accessing the storage module via the simulation module;
determining whether to load the operating system from the optical disk drive by the processor based on setting of the BIOS; and
reading operation requested by the processor is conducted by the optical drive disk to access the operating system stored within the storage module when it is determined to load the operating system from the optical disk drive.

17. The operating system loading method according to claim 16, further comprising a step of resetting the optical disk drive after completing loading of the operating system and disabling the simulation function.

18. The operating system loading method according to claim 16, further comprising a step of determining whether the simulation module is activated or not based on a mode-switching signal so as to conduct the simulation function.

19. The operating system loading method according to claim 18, wherein the optical disk drive further includes an outer casing and a function switch mounted on and exposed to said outer casing, said mode-switching signal being generated when function switch is pressed or released.

20. The operating system loading method according to claim 18, wherein the optical disk drive further includes an outer casing and an ejection button mounted on and exposed to said outer casing, said mode-switching signal being generated when a predetermined number of pressing actions are applied onto said ejection button or when said ejection button is pressed beyond a predetermined time interval.
